(19) United States
(12) Patent Application Publication
(10) Pub. No.: US 2011/0283218 A1
(43) Pub. Date: Nov. 17, 2011

(54) Electronic Event Planner in Communication Device

(75) Inventors: Lauren E. Schwendimann, Chicago, IL (US); JoEllen C. Kames, Chicago, IL (US)

(73) Assignee: MOTOROLA, INC., Schaumburg, IL (US)

(21) Appl. No.: 12/779,715

(22) Filed: May 13, 2010

(51) Int. Cl. G06F 3/048

(52) U.S. Cl. 715/772

(57) ABSTRACT

A communication device including a controller coupled to a user interface wherein the controller is configured to recommend an event and a proposed time at which the event occurs based on tentative time and participant information provided to, or obtained by, the communication device. The participant information identifies an individual with which a user of the communication device may participate in the event. The recommended event and proposed time is communicated to the participants.

### FIELD OF THE DISCLOSURE

The present disclosure relates generally to communication devices and, more particularly, to interactive event planning in communication devices, including portable wireless communication devices, and corresponding methods.

### BACKGROUND

Electronic calendar applications are known generally. Such applications include, among others, Microsoft Outlook, which runs on personal computers and mobile communication devices like cellular telephone handsets. These and other electronic calendars permit the user to schedule an appointment on the calendar and to distribute an invitation to potential attendees thereby enabling the coordination and scheduling of appointments. In some networked environments, the calendar application indicates the availability of potential attendees running similar applications before the invitation is sent. The calendar application also permits acceptance or declination of the invitation by invitees. In known electronic calendars, however, there are no means for users to “pencil something in” and to plan events that are not yet fully conceived, or to plan events that require group coordination or collaboration and/or additional information before scheduling a firm date on the calendar.

The various aspects, features and advantages of the disclosure will become more fully apparent to those having ordinary skill in the art upon careful consideration of the following Detailed Description thereof with the accompanying drawings described below. The drawings may have been simplified for clarity and are not necessarily drawn to scale.

### BRIEF DESCRIPTION OF THE DRAWINGS

FIG. 1 is schematic of an electronic device.

FIG. 2 is a schematic process flow diagram.

FIG. 3 is a more detailed process flow diagram.

FIG. 4 is another schematic process flow diagram.

### DETAILED DESCRIPTION

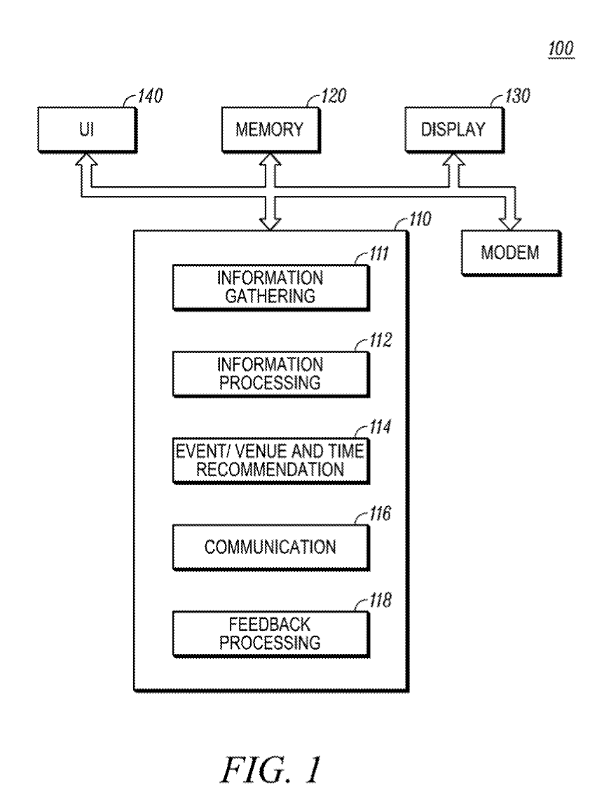

In FIG. 1, an electronic device 100 comprises a controller 110 coupled to memory 120, a display 130, and user interface elements 140. In some embodiments other elements also constitute of the electronic device, some of which are discussed further below. The user interface elements may include, but are not limited to, a keypad and/or touch screen suitable for inputting alphanumeric and other symbolic characters or information, audio inputs and outputs, and gesture sensors among other user interface elements now know or later developed. The type, location and configuration of the user interface elements, including the display, are not particularly relevant to the subject of the disclosure and thus the particular implementation of the user interface and corresponding user interface elements described herein is not intended to limit the disclosure. Generally the user interface may be considered an information interface, or interface, of the electronic device insofar as information is received by the device at the user interface.

The electronic device may be implemented as a portable device or a relatively fixed station capable of implementing functionality described herein. A portable device may be embodied as a wireless communication handset, a laptop or notebook computer, a portable browsing device, an Internet tablet, or a personal organizer, with or without communications capabilities. A fixed station may be embodied as a personal desktop computer, workstation, or some other relatively immobile electronic device. The particular implementation of the electronic device, portable or otherwise, is manifold and thus the exemplary wireless communication handset described herein is not intended to limit the disclosure.

In one implementation, the electronic device is a communication device having a communication modem, which may be implemented as a wire-line or as a wireless transceiver. In FIG. 1, the electronic device includes a communications transceiver or modem 150. In a more particular implementation, the electronic device is embodied as a portable wireless communication device comprising one or more wireless transceivers. For example, the transceiver may be a cellular transceiver, a WAN or LAN transceiver, a personal space transceiver (e.g., a Bluetooth transceiver), a near field transceiver, a satellite signal transceiver, or some other wireless transceiver. In other embodiments however one or more of the transceivers or modems may be wire-line transceivers. A combination of two or more of such transceivers is also envisaged. The electronic device may also include a satellite positioning system (SPS) receiver (e.g., a GPS, GLONASS or Galileo receiver), a television or radio signal receiver, a one-way communication receiver, or some other receiver. The receiver may be used alone or in combination with one or more communications transceivers as suggested. The transceiver or receiver may be also considered an interface of the electronic device.

In one embodiment, the controller is embodied as a programmable processor that executes firmware or software stored in one or more memory devices wherein the firmware or software enables, implements and controls functionality of the electronic device. The memory may be embodied as one or more discrete devices including, but not limited to, volatile or nonvolatile memory such as random access memory and read-only memory, among other memory devices. In FIG. 1, for example, the controller 110 controls the functionality of the display 130, the user interface elements 140, and the modem 150, among other elements and functionality of the device. In some embodiments, the controller 110 controls or manages other processors that perform dedicated processing tasks. These other processors may include, among other dedicated processors, a video processor that processes video information presented on the display 130, and a baseband processor that processes communication signals communicated to and from the communications transceiver 150. Alternatively, the functionality of the electronic device may be implemented by equivalent hardware circuits or modules, or by a combination of software and hardware circuits. The enablement of the basic functionality of electronic devices including wireless communication devices, personal electronic organizers and other portable electronic devices is known generally by those having ordinary skill in the art and is not discussed further herein.

In some electronic devices including a programmable processor, the device also includes an operating system that accommodates one or more software-based applications. In wireless communication handset implementations, for example, the operating system could be embodied as an ANDROID, WINDOWS MOBILE, SYMBIAN or some other proprietary or non-proprietary operating system. In fixed base implementations, the electronic device may also include some other operating system like WINDOWS or a LINUX or UNIX based operating system, among others. More generally, however, the electronic device does not include an operating system. In some embodiments, the functionality is controlled by embedded software or firmware and in other embodiments the functionality is implemented by hardware equivalent circuits or a combination of hardware and software controlled circuits. The particular architecture of the operating system and/or processor executable programs and/or hardware that implements and controls the functionality of the electronic device is not intended to limit the disclosure.

According to one aspect of the disclosure the electronic device includes interactive event planning functionality. In one embodiment, the event planning functionality is implemented as an application run on or executed by a digitally programmable controller or processer of the electronic device, for example, the controller 110 of FIG. 1. Generally, the interactive event planning functionality recommends one or more events and times based on information provided to or obtained by the electronic device. Such information is generally provided via the interface of the electronic device, for example, via the user interface, receiver or a data port of the device. In some embodiments, the interactive event planner communicates with other devices and services during the planning process to obtain information about participants with whom the events are planned. In other embodiments, however, the information about the other participants is stored locally on the electronic device, thereby eliminating the need for the device to communicate with the other devices during the event planning process. Such devices may have previously stored information about the other participants. The interactive event planner may also interact directly with participants other than the user, via the respective communication devices or services, during the event planning process. In some embodiments, the other communication devices that the interactive event planner interacts with also include interactive event planning functionality. In other embodiments, however, the other communication devices with which the interactive destination planner interacts do not include event planning functionality. It is generally necessary for only one device to include the interactive event planning functionality.

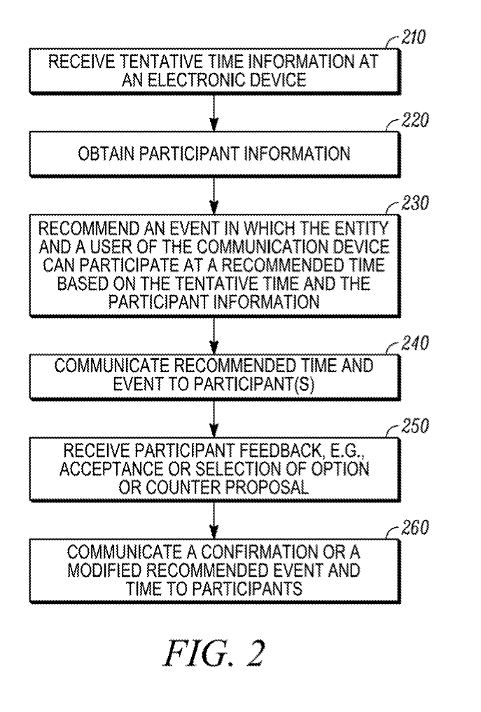

FIG. 2 describes an interactive event planning process from the perspective of the communication device of the user seeking an event recommendation. In FIG. 2, at 210, the algorithm receives tentative time information, usually upon the user inputting the information into the electronic device at a user interface of the device. The tentative time information generally includes date and/or time of day information. Only time of day information may be input if the date is known a priori. The user may input the information audibly or by tactile interaction with the electronic device. Alternatively, the algorithm may obtain the tentative time information from another application running on the device. For example, the user may select the tentative time from a calendar or some other application running on the device and export the tentative time information to the interactive event planning algorithm. The algorithm may also obtain the tentative time information from some other device or entity communicably connectable to the electronic device.

In FIG. 2, at 220, the interactive event planning algorithm obtains or receives participant information, which may be obtained locally or from a remote source as described further below. The user may input this information at the user interface of the communication device. The participant information generally identifies an entity, for example, an individual or a group of individuals that may participate in the event recommended by the interactive event planner. This information may be input in a manner similar to the time information described above. The participant information may also be exported manually or automatically from some other application. For example, the user may select the participant information from a contacts list, an electronic message, or from another application and export the participant information to the interactive event planning algorithm. In some instances both the tentative time and the participant information are obtained from a common application or other common source. In FIG. 1, the controller 110 is configured to execute or implement information acquisition functionality 111 by instructions stored in memory. While FIG. 1 characterizes the information acquisition as functionality performed by a programmed processor, equivalent functionality may also be performed by an equivalent hardware circuit or module. In some embodiments, more generally, the controller obtains other information, not necessarily input by the user, for use in the event planning process as described further below. In FIG. 2, the order in which the tentative time and participant information is input to or obtained by the communication device is not particularly relevant.

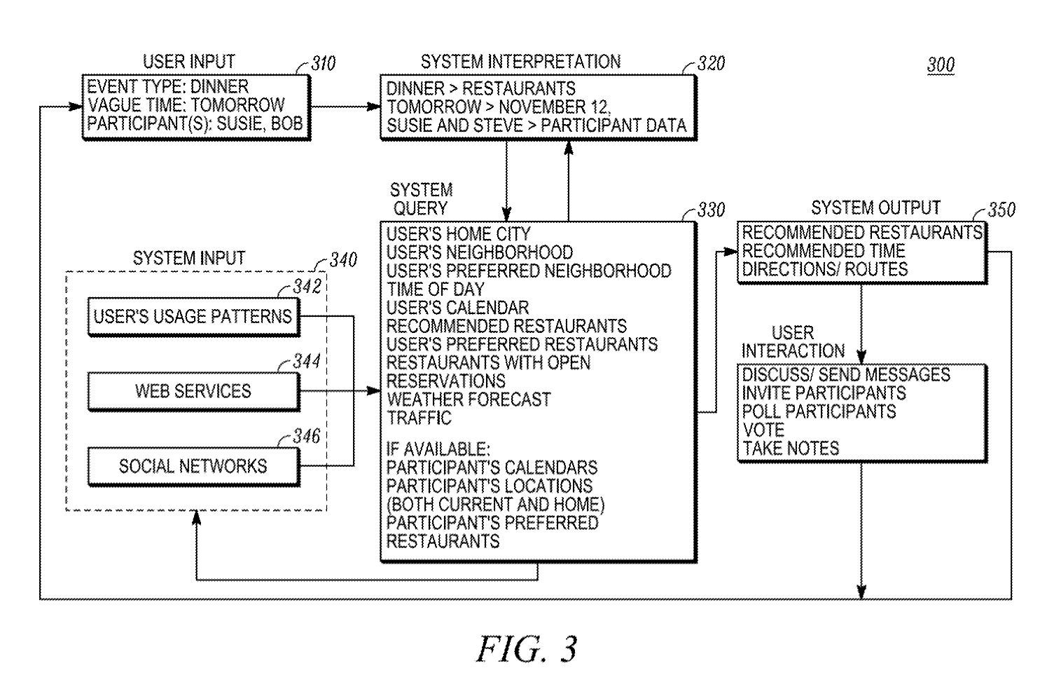

In the more detailed process diagram 300 of FIG. 3, at 310, participant information and vague or tentative time information is input to, or otherwise obtained by, electronic device. At 320, the interactive event planning algorithm interprets the tentative time and participant information. Generally, the controller processes the information input at 310 and any other information before making a recommendation. For example, the controller may quantify vague time information period like “next week” in terms of a specific date or in terms of a range of dates. Similarly, a vague time like “later today” may be quantified in terms of one or more ranges of time periods, e.g., between 7:00 pm and 11:00 pm. The participant information may also be verified and quantified. More generally, any information that is considered in the event planning process is interpreted or processed by the controller at 320. For example, the controller may determine overlapping availability of the participants, a relationship (e.g., personal, professional, etc.) of or between the participants, among other information. More specific examples of information that may be processed and how it is processed as part of the event planning process are described below. Thus any information that is considered in the event planning process is also interpreted or processed by the controller at 320. The processing functionality may be enabled by programmed instructions stored in memory and executed by a processor. Thus in FIG. 1 the controller 110 is configured to execute or implement information processing functionality 112 by instructions stored in memory. While FIG. 1 characterizes the information processing as functionality performed by a programmed processor, equivalent functionality may also be performed by an equivalent hardware circuit or module.

In FIG. 2, at 230, the interactive event scheduling algorithm implemented by the controller recommends an event and a proposed time based on the tentative time and the participant information input to the electronic device. The algorithm may also recommend a proposed time and venue in which the recommended event will or may occur. Alternatively, multiple alternative events, venues and/or times may be recommended. In FIG. 1, the controller 110 is configured to implement or execute event and time recommendation functionality 114 by instructions stored in memory. While FIG. 1 characterizes the recommendation functionality as being performed by a programmed processor, equivalent functionality may also be performed by an equivalent hardware circuit or module.

Generally, the one or more events recommended are based on preference information for the user of the device and/or one or more of the identified participants. The preference information is meant to include user or participant preferences as well as participant characteristics or profile information, e.g., gender, orientation, occupation, interests, dislikes, etc., among any other information that may be available to the algorithm and with which the algorithm may use as a basis for making a recommendation. The preference information may be provided to the algorithm by the user seeking the event recommendation. Alternatively, the algorithm may query a local or remote repository for such information. The algorithm may also give consideration to past or historical participant interaction, which may be stored locally or remotely.

In FIG. 3, at 330, the algorithm implemented or executed by the controller performs one or more queries to identify the preference information for the user and/or for the other participant(s). This information may then be made available for interpretation and processing at 320. Generally, the controller may obtain the preference information from one or more of many different sources 340 external to the communication device. However some of this information may also be stored locally on the communication device. While some profile information may be stored locally on the communication device for some participants, more information may be available from remote or external sources. FIG. 3 identifies several exemplary external sources from which the controller may obtain relevant preference information. The preference information may include, but is not limited to, participant usage or behavior patterns 342, web services 344, and social networks 346, among others. Exemplary social networks from which the preference information may be obtained include Facebook, Myspace and LinkedIn, among other networks. Other social networks from which participant preference information may be obtained include music networks like LastFM and I-Like. Yelp! is a recommendation network that may also be a source of participant preference information. These exemplary participant preference sources are not intended to be inclusive or to limit the disclosure. In FIG. 1, access to remote information repositories is performed by the information acquisition functionality 111.

As suggested, some of the preference information may be accessible to the algorithm as profile information stored locally on the communication device. The profile information may include name, age, gender, interests, location, favorites (e.g., music movies, or other media, websites, restaurants, sports, teams, etc), usage patterns, memberships, medical information, among other information and combinations thereof. The profile information may also include dynamically changing information about the participant, e.g., location, mental or emotional disposition etc., some examples of which are discussed further below. This and other profile information may be input manually or it may be obtained locally or from a remote source, like a social network or some other network-based source of information, examples of which are also described herein.

In one embodiment, the algorithm executed by the controller determines an interest common to both the one or more participants and the user of the communication device and then recommends one or more events based on the common interest. In one embodiment, for example, the user and participants have both specified an overlapping tentative time during the dinner hour, and the common interest is food. The recommended event could thus be dining out at a particular time and venue. The recommendation may be more particular if more detailed information is available to the algorithm making the recommendation. For example, if the preference information includes a specific type of restaurant common to both parties, the recommendation may recommend a particular restaurant type, e.g., Greek, Italian or Japanese. If the preference information includes a specific restaurant name common to both parties, a restaurant venue may be recommended by name. If multiple restaurants satisfy preferences common to both parties, the event planner may recommend more than one restaurant. The event planner algorithm may also prioritize multiple recommended events. Generally, the selection of the event could be based on the proposed time or based on the availability of the parties. For example, if the proposed time is a weekend evening, a restaurant with more formal dining accommodations may be recommended. In another example, if the proposed time is on a Sunday afternoon and the participants have a common interest in sports, a favorite sports bar may be recommended. Other examples are described below.

The availability of the participants could be based solely on the tentative time provided initially or based on more specific availability information obtained from the parties in response to the event recommendation. More specific availability information could be based on specific times that the participants are available within a tentative time range initially provided to the algorithm. The more specific participant availability information may be later obtained from the participants, for example, from calendar applications or from social networks where the participants make their schedules available. The participants may also provide more specific availability information in response to a query generated by the algorithm and communicated to the participants by electronic device. Under these circumstances, the communication device hosting the event planning algorithm is in communication with the communication device of at least one other participant during the planning process.

In other embodiments, multiple preferences other than the proposed time are used as a basis to recommend an event. In the dining example, above, if the participants are business or professional colleagues, the recommended dining venue may be different than if the participants are personal friends or recent acquaintances. Similarly, a different dining venue may be recommended for participants engaged in a team sport than for professional colleagues. Thus, generally, more detailed and uniquely tailored recommendations may be made where more particular participant preference information is made available to the interactive event planning algorithm.

In another embodiment, the controller obtains state of mind information about either the participant or the user of the device, or both, and recommends a proposed time and event based at least partly on the state of mind information. The state of mind information could be an emotional disposition or the mood of the participants. This information may be made available and updated regularly on some social networks and in other venues accessible to the algorithm of the electronic device. Such state of mind information may be “happy”, “sad”, “depressed”, “stressed”, “ecstatic”, “busy” among many other mental states that can be described and made accessible to the algorithm. According to this embodiment, the state of mind may be accessed and used as preference information for the purpose of recommending an event. In the dining example described above, for example, if the parties are “busy”, the recommended venue may be a fast-food restaurant. The state of mind preference may be used in isolation or in combination with other preference information. In FIG. 1, this state of mind preference information is gathered by the information acquisition functionality 111.

In another embodiment, the controller obtains physical health information about a participant or the user of the device, or both, and recommends the time and event based on the physical health information. For circumstances where one or more of the participants has an infectious ailment, the algorithm may recommend that the participants interact remotely. For example, if the participants enjoy on-line gaming, the algorithm may recommend an on-line gaming event.

Generally, the one or more recommendations are communicated to at least one of the participants, typically the user seeking the event recommendation. The recommendations may be communicated to the user of the device at a user interface of the device and/or via a message. The recommendation may also be communicated to other participants or invitees. The communication may be made to the other participants by transmitting a message, for example, email or some other message or communication. In FIG. 2, the process diagram illustrates such a communication at 240. In FIG. 3, at 350, the system outputs the recommended event/venue and tentative time information. In some embodiments, the algorithm may also provide directions or routing information. The one or more event/venue recommendations and other information may be communicated to the user and the other participants in a message. Such a message may be an e-mail message or some other electronic message like a text message or an instant message (IM) or an electronic meeting invitation typical of some calendar applications. For such messaging to occur, in some implementations, the event planning algorithm includes messaging functionality or the algorithm is interfaced to a separate messaging application, like an e-mail or IM application or to a calendar application like MICROSOFT OUTLOOK. In FIG. 1, the controller 110 is configured to implement or execute event and time communication functionality 116 by instructions stored in memory. While FIG. 1 characterizes the communicating functionality as being performed by a programmed processor, equivalent functionality may also be performed by an equivalent hardware circuit or module.

In response to the communication of the event and other recommendations, the one or more participants may provide feedback with which the interactive event planning algorithm may generate and communicate one or more updated recommendations. The original recommendation may thus be refined or revised. In FIG. 2, at 250, the algorithm receives feedback from the participants. The participant feedback may be a mere acceptance of recommendation. If all participants accept the recommendation, the algorithm may in some embodiments communicate a confirmation notification. In FIG. 2, at 260, the algorithm communicates a confirmation to the participants if the participants accept the recommendation. In some embodiments, upon confirmation, the algorithm may schedule the event and time in a calendar or other application for the one or more participants. The interactive scheduling algorithm may be a part of a calendar application or the calendar application may be separate.

In some embodiments, the algorithm refines the initial event and time recommendation based on the feedback provided by one or more participants. In FIG. 1, the controller 110 is configured to implement or execute recommendation update functionality at 114 by instructions stored in memory. The revised recommendation is then communicated to the participants, which can then accept, decline or propose new terms. The iteration may be continued and further revised or refined until the participants ultimately accept or decline. In one use case, the feedback provided by the participants is in the form of a prioritization of several events proposed by the algorithm. Based on such feedback, the algorithm may recommend one of the prioritized events, giving consideration to any feedback provided by other participants. The participants may also provide feedback by selecting one of several events recommend by the algorithm. Alternatively, the participants may propose a new or different event than that recommended by the algorithm. The feedback provided by the participants may also be in the form of a prioritization of several times proposed by the algorithm. Based on such feedback, the algorithm may recommend one of the prioritized times giving due consideration to any time-related feedback provided by the other potential participants. The participants may also select one of several times recommend by the algorithm and feedback the selected time. Alternatively, the participants may propose a new or different time than the time or times recommended by the algorithm. In FIG. 1, the controller 110 is configured to implement or execute participant feedback processing functionality at 118 by instructions stored in memory. While FIG. 1 characterizes the feedback processing functionality as being performed by a programmed processor, equivalent functionality may also be performed by an equivalent hardware circuit or module.

In some embodiments, the controller is configured to obtain contextual information about the participants. Examples of such contextual information include but are not limited to time of day, day, participant schedule, participant location, participant environment, and weather information, among other information. Contextual information may be obtained from Instant Messaging (IM) or presence servers or a location service like Foursquare or Loopt or from other sources, examples of which were discussed above. According to this aspect of the disclosure, the proposed time and event are at least based on the contextual information. The algorithm generally uses the participant contextual information in combination with other information about the participants when making recommendations.

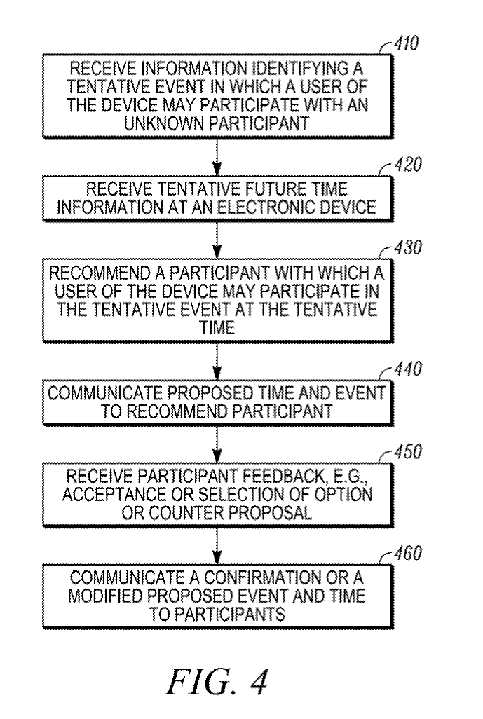

FIG. 4 illustrates an alternative interactive event planning and scheduling process implemented on a communication device. The process is described from the perspective of the electronic device. In FIG. 4, at 410, the algorithm receives information identifying a tentative event in which a user of the device may participate with an unknown entity (e.g., participant) at a tentative future time. As described above, this information may be provided to the algorithm by the user at a user interface of the communication device. In FIG. 1, the controller 110 is configured to execute or implement information acquisition functionality 111 by instructions stored in memory. In FIG. 2, at 220, the interactive event planning algorithm receives. In FIG. 3, the tentative event and vague time are input to the electronic device or algorithm at 310.

In FIG. 4, at 420, the algorithm receives tentative time information, usually upon the user inputting the information into the electronic device at a dedicated user interface of the device. This information may be input as described above in connection with FIG. 2. In FIG. 4, the order in which the tentative event and time information is input to the device is not particularly relevant. At 430, the algorithm recommends a proposed participant with whom the user of communication device may participate with in the tentative event. In one embodiment, the recommendation is made based on the tentative future time and based on information common to the user of the communication device and to the proposed entity. The information about potential participants may be obtained by the algorithm from a local or external information repository, or both. In FIG. 3 for example, the communication device may obtain relevant information from an information repository 340 by making a system information query at 330. Information about a pool of potential participants may also be stored on the communication device.

In one implementation, the algorithm identifies the recommended participant or individual based on information indicating that the participant or individual has an interest in the tentative event input to the communication device. The determination may also be made based on common interests between the user of the device and potential participants. Various other criteria may also be used as a basis for recommending the participant including but not limited to the location of the event and/or the location of the participants. Such determinations may be made based on participant preference or profile information obtained by the algorithm. In another embodiment, the individual is recommended based on information indicating that the individual is available at the tentative future time input to the communication device.

In FIG. 4, at 440, the proposed time and event are communicated to at least the recommended participant. In some embodiments, the communication occurs only after the user of the communication device accepts the recommendation. At 450, the algorithm receives feedback from the participants. The feedback may be a mere acceptance of the proposed time and event. If all participants accept the proposal, the algorithm may communicate a confirmation notification. In some embodiments, upon confirmation, the algorithm may schedule the event and time in a calendar application for the participant. The interactive scheduling algorithm may be a part of the calendar application or the calendar application may be separate. At 460, the algorithm communicates a confirmation to the participants if the participants accept the recommended event and time. Alternatively, the algorithm communicates a revised recommendation based on the participant feedback. These and other aspects of the disclosure relevant to the communication and feedback acts of FIG. 4 are discussed more fully above, particularly with respect to FIG. 2.

While the present disclosure and the best modes thereof have been described in a manner establishing possession by the inventors and enabling those of ordinary skill to make and use the same, it will be understood that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A communication device comprising:
a user interface;
a controller coupled to the user interface,
the controller configured to recommend an event and a proposed time at which the event will occur based on a tentative time and based on participant information obtained by the communication device,
the participant information identifying an entity with which a user of the communication device is to participate in the event,
the controller configured to present the recommended event and proposed time on the user interface.

2. The device of claim 1, the controller configured to recommend the proposed time and a venue at which participation in the event will occur at the user interface.

3. The device of claim 2,
the controller configured to obtain the preference information about the entity or the user of the communication device,
the controller configured to recommend an event and a proposed time at which the event will occur based on the preference information.

4. The device of claim 1 further comprising a communication transceiver,
the entity is an individual,
the controller configured to obtain preference information about the individual from a remote information source via the communication transceiver,
the controller configured to recommend an event and a proposed time at which the event will occur based on the preference information.

5. The device of claim 1,
the entity is an individual,
the controller configured to obtain information about the entity or the user of the communication device,
the controller configured to recommend an event and a proposed time at which the event will occur based on an interest common to both the individual and the user of the communication device.

6. The device of claim 1,
the entity is an individual,
the controller configured to obtain state of mind information about the individual,
the controller configured to recommend an event and a proposed time at which the event will occur based on the state of mind information about the individual.

7. The device of claim 1,
the entity is an individual,
the controller configured to obtain physical health information about the individual,
the controller configured to recommend an event and a proposed time at which the event will occur based on the physical health information about the individual.

8. The device of claim 1 further comprising a communication transceiver,
the entity is an individual,
the controller configured to cause the communication transceiver to communicate the proposed time and event to the individual and to obtain feedback from the individual in response to the communication.

9. The device of claim 1,
the entity is an individual,
the controller configured to obtain contextual information about the individual and about the user of the communication device,
the controller configured to recommend an event and a proposed time at which the event will occur based on the contextual information.

10. A communication device executing an event scheduling and planning application, comprising:
receiving information identifying a tentative event in which to participate with an unknown entity at a tentative future time;
recommending a proposed entity with which to participate in the tentative event with a user of the communication device,
the proposed entity recommended based on the tentative future time and based on information common to the user of the communication device and to the proposed entity.

11. The method of claim 10, the proposed entity is an individual, identifying the proposed individual based on information indicating that the individual has an interest in the tentative event.

12. The method of claim 11, recommending the individual based on information indicating that the individual is available at the tentative future time.

13. The method of claim 10,
the proposed entity is an individual,
communicating the tentative event to the individual, and
receiving feedback from the individual in response to the communication.

14. The method of claim 10,
requesting information from the proposed entity,
recommending the proposed entity based on information received from the proposed entity in response to the request.

15. The method 10, recommending the proposed entity based on a location of the tentative event and based on a location of the user of the communication device.

16. The method 10, recommending the proposed entity based on a location of the potential entity and based on a location of the user of the communication device at the tentative event future time.

17. The method 10, the potential entity is an individual, recommending a revised tentative future time after recommending the individual.

18. A method in a communication device executing an event scheduling and planning application, comprising:
receiving information identifying a potential entity to participate in an unknown event at a tentative future time for the application;
recommending a proposed event for participation in by the potential entity identified and a user of the communication device,
the proposed event recommended based on the tentative future time and based on information about the potential entity and based on information about the user of the communication device.

19. The method of claim 18, the potential entity is an individual, obtaining personal preference information about the individual from an information source, recommending the proposed event based on personal preference information about the individual.

20. The method of claim 18, recommending the proposed event based on an interest common to the potential entity and to the user of the communication device.
